(19) United States
(12) Patent Application Publication
(10) Pub. No.: US 2015/0340715 A1
(43) Pub. Date: Nov. 26, 2015

(54) FUEL CELL POWER GENERATING SYSTEM

(71) Applicant: M-field Energy LTD., Taipei City (TW)

(72) Inventors: WEN-SHIH CHANG, Hsinchu City (TW); SHENG-CHIN MEl, New Taipei City (TW); KE-CHIAO LIN, Hisnchu City (TW)

(73) Assignee: M-field Energy LTD., Taipei City (TW)

(21) Appl. No.: 14/283,385

(22) Filed: May 21, 2014

(51) Int. Cl. H01M 8/04

(52) U.S. Cl. CPC H01M 8/04074; H01M 8/04014; H01M 8/04126; H01M 8/04164; H01M 8/04201

(57) ABSTRACT

A fuel cell power generating system has a fuel cell module which can generate electricity when oxygen and hydrogen are supplied to the fuel cell module and have a reaction therein. A cooling subsystem provides coolant to flow through the fuel cell module to take heat away therefrom. Heat in the coolant is used to heat at least one of fluid for heating and humidifying air before the air enters the fuel cell module and fluid for heating and humidifying the hydrogen before the hydrogen enters the fuel cell module.

### FIELD

The present disclosure relates to a fuel cell power generating system, and particularly to a fuel cell power generating system having an improved thermal management regarding heat produced during operation of the fuel cell power generating system.

### BACKGROUND

A fuel cell power generating system has many advantages over other power generating systems such as higher energy efficiency, clean and eco-friendly, easy maintenance, installation simplicity and operating stability, whereby the fuel cell power generating system has become more and more popular.

The fuel cell power generating system includes a fuel cell module consisting of a plurality of fuel cells. Each fuel cell is an electrochemical device which converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange membrane (PEM) fuel cell.

Taking the PEM fuel cell as an example, the PEM fuel cell includes a proton exchange membrane, which permits only protons to pass between an anode and a cathode of the fuel cell. At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water. The water is typically removed with the cathode exhaust stream, which can dehydrate the PEM unless the removed water is timely supplemented. It should be noted that the rate of evaporation to the cathode is generally greater than the rate of water generation. Therefore, effective operation of the PEM fuel cell requires proper humidification of the PEM to maintain its proton conductivity.

In the PEM fuel cell, air and temperature management remains one of the major design considerations in order to maintain proper humidification of the PEM. If water is evaporated too quickly, the membrane dries, resistance across it increases, and eventually it will crack, thereby creating a direct path for hydrogen and oxygen to combine, which can generate heat that would damage the fuel cell. If the water is evaporated to slowly, the cathodes will be flooded, thereby preventing the reactants from reaching the catalyst and stopping the reaction. In addition, the temperature must be controlled throughout the cell in order to prevent destruction of the cell through thermal loading. This is particularly challenging as the 2H₂+O₂=2H₂O reaction is highly exothermic, so a large quantity of heat is generated within the fuel cell. The heat produced by the fuel cell module is normally dissipated to the atmosphere by a cooling system. Alternatively, the heat can be recovered and utilized for heating the reactant fluids, or the heat can be utilized for other heating requirements, such as in a combined heat and power (CHP) generator. However, the heat recovery efficiency is often not optimized; thus, a large amount of heat is wasted.

Ideally, the water should be evaporated at the same rate that it is produced. However, the evaporated water cannot be normally collected and recycled back to the fuel cells at 100% efficiency due to non-optimized thermal energy recovery and low efficiency of conventional drain traps. Therefore, for a PEM fuel cell power generator, particularly a mid-capacity PEM fuel cell power generator such as a 100 kW power generator, proper humidification and thermal managements are usually realized by external supplies, such as providing external water supplies to the humidifiers and coolant tanks, or providing external heaters to the humidifiers to humidify the reactant fluids. The external supplies consume additional electrical energy and add complication to the systems due to additional components and sensors, and can therefore result in an inferior cost-performance ratio.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present fuel cell power generating system. Moreover, in the drawings, like reference numerals designate corresponding parts throughout the several views.

FIG. 1 is a diagram showing an overall configuration of a fuel cell power generating system according to a first embodiment of the present disclosure.

FIG. 2 is a diagram showing an overall configuration of a fuel cell power generating system according to a second embodiment of the present disclosure.

FIG. 3 is a diagram showing an overall configuration of a fuel cell power generating system according to a third embodiment of the present disclosure.

FIG. 4 is a diagram showing a partial configuration of a fuel cell power generating system according to a fourth embodiment of the present disclosure.

FIG. 5 is a diagram showing a partial configuration of a fuel cell power generating system according to a fifth embodiment of the present disclosure.

### DETAILED DESCRIPTION OF EMBODIMENTS

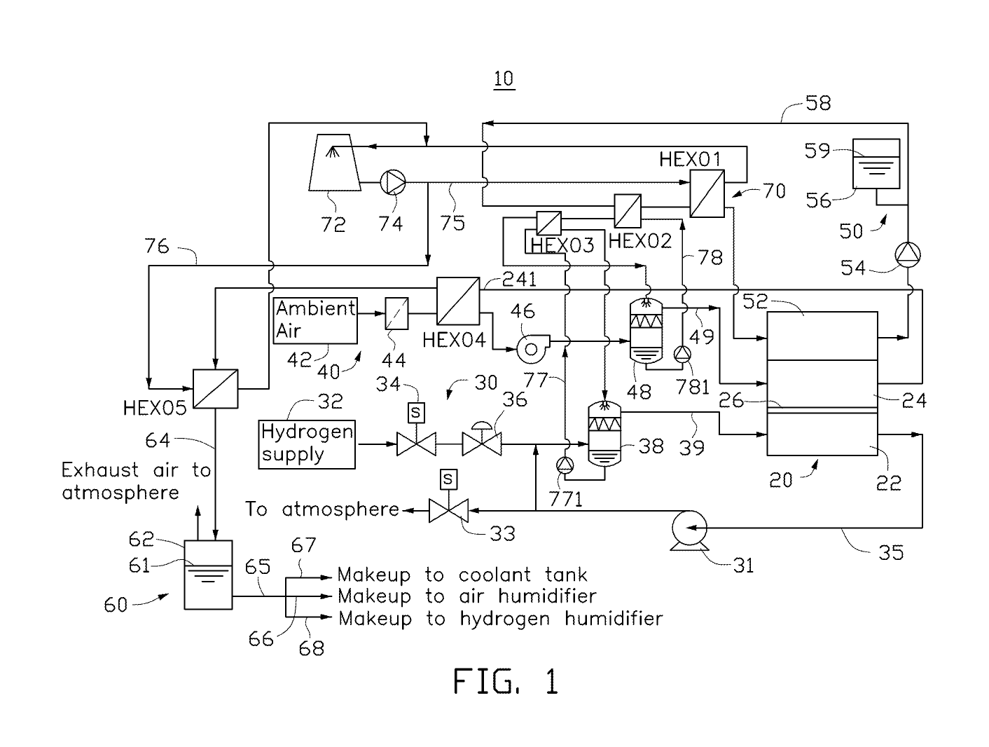

Referring to FIG. 1, a fuel cell power generating system 10 in accordance with a first embodiment of the present disclosure includes a fuel cell module 20, a hydrogen (fuel) supply subsystem 30, an air (oxidant) supply subsystem 40, a coolant flow subsystem 50, a product water recycling subsystem 60 and a thermal management subsystem 70. According the present disclosure, the fuel cell power generating system 10 is a 100 kW mid-capacity fuel cell power generating system which has an approximately 150 kW of heat dissipation requirement. The fuel cell module 20 can include at least one set of fuel cell sub-module (not shown), wherein the at least one fuel cell sub-module can include at least one fuel cell stack (not shown). The fuel cell module 20 can be connected to a DC/AC inverter (not shown) which can be connected to the grid. The balance of plant (BOP) module (not shown) in the system 10 can be supplied by external AC power supply. The system 10 can be contained in a standard-sized 20 ft container, and the system 10 can be controlled and monitored by a remote control system such as Labview.

The fuel cell module 20 includes a plurality of fuel cell stacks each including an anode 22, a cathode 24 and a solid polymer membrane 26 between the anode 22 and cathode 24.

The hydrogen (fuel) supply subsystem 30 includes a hydrogen supply 32, an On/Off valve 34, a pressure regulator 36, a first humidifier 38 and a first pipeline 39 which interconnects the hydrogen supply 32, the On/Off valve 34, the pressure regulator 36 and the first humidifier 38 together and connects the first humidifier 38 of the hydrogen (fuel) supply subsystem 30 with an inlet of the anode 22 of the fuel cell module 20. The first humidifier 38 is a hydrogen humidifier. The hydrogen (fuel) supply subsystem 30 further comprises a recirculation pump 31, a purge valve 33 and a second pipeline 35 connecting an outlet of the anode 22 with an inlet of the recirculation pump 31 and an outlet of the recirculation pump 31 with the first pipeline 39 and the purge valve 33.

Pure hydrogen gas is used as fuel in the fuel cell power generating system 10. The hydrogen gas is stored in an external hydrogen storage at the hydrogen supply 32. The hydrogen gas enters the system 10 through the On/Off valve 34 and the hydrogen gas is de-pressurized to around 300 mbar through the pressure regulator 36 subsequent to the On/Off valve 34. A pressure transmitter (not shown) is attached to the pressure regulator 36 to monitor and to provide control to the pressure level of the hydrogen gas before introducing the hydrogen gas to the fuel cell module 20. The anode exhaust gas is recycled back to the first humidifier 38 through the recirculation pump 31 in order to reuse the non-reacted hydrogen gas. The first humidifier 38 is located subsequent to the pressure regulator 36 and functions to ensure the hydrogen gas has an elevated temperature and humidity before it is introduced into the fuel cell module 20. The first humidifier 38 is a packed-beds humidifier. The hydrogen gas flows through the curled channels within the packed beds, wherein the high surface areas of the packed beds would heat and humidify the hydrogen gas.

The air (oxidant) supply subsystem 40 includes an ambient air supply 42, a filter 44, a blower 46, a second humidifier 48 and a third pipeline 49 which interconnects the ambient air supply 42, the filter 44, the blower 46 and the second humidifier 48 together and connects the second humidifier 48 of the air (oxidant) supply subsystem 40 with an inlet of the cathode 24 of the fuel cell module 20. The second humidifier 48 is an air humidifier. When the blower 46 works, air in the ambient air supply 42 can be drawn to flow through the second humidifier 48 and the cathode 24.

Air is used as oxidant in the fuel cell power generating system 10. The oxygen in the air reacts with the hydrogen in the anode 22 of the fuel cell module 20. During system operation, the ambient air enters the system 10 through the air filter 44 and subsequently through the air blower 46 (air pump or air compressor). The dried ambient air needs to be humidified first through the second humidifier 48 located sequent to the air blower 46 before the air is introduced into the cathode 24 of the fuel cell module 20. The temperatures of cathode exhaust gas and product water can be monitored by a thermocouple (not shown) and the product water is recycled to the second humidifier 48 to humidify the air therein. The air has an elevated humidity before it is introduced into the fuel cell module 20.

The coolant flow subsystem 50 includes a cooling plate 52 in thermal connection with the fuel cell module 20 whereby heat generated during operation of the fuel cell module 20 can be effectively absorbed and dissipated by the cooling plate 52, a first pump 54, a coolant tank 56 and a fourth pipeline 58 interconnecting the first pump 54, the coolant tank 56 and cooling plate 52 together. When the first pump works 54, water 59 can circulate in the fourth pipeline 58 to flow through the cooling plate 52 to take the heat away from the fuel cell module 20.

The product water recycling subsystem 60 includes a product water tank 62, a fifth pipeline 64 connecting an outlet of the cathode 24 with a top of the product water tank 62, a sixth pipeline 65 having a first manifold 66 connecting a bottom of the product water tank 62 with the second humidifier 48, a second manifold 67 connecting the bottom of the product water tank 62 with the coolant tank 56 and a third manifold 68 connecting the bottom of the product water tank 62 with the first humidifier 38. Product water 61 in the product water tank 62 can be supplied to the coolant tank 56 via the second manifold 67 to supplement the water 59 therein if the water 59 is lost beyond a certain level after a period of operation of the fuel cell power generating system 10. The product water 61 can also be supplied to the second humidifier 48 via the first manifold 66 to supplement water therein if the water is lost beyond a certain level. Finally, the product water 61 can further be supplied to the first humidifier 38 via the third manifold 68 to supplement water therein if the water is lost beyond a certain level.

The thermal management subsystem 70 includes first, second, third, fourth and fifth heat exchangers HEX01, HEX02, HEX03, HEX 04, HEX 05, a cooling tower 72, a second pump 74, a seventh pipeline 75 interconnecting an inlet and an outlet of the cooling tower 72 via the first heat exchanger HEX01, an eighth pipeline 76 interconnecting an outlet of the second pump 74 and the inlet of the cooling tower 72 via the fifth heat exchanger HEX05, a ninth pipeline 77 interconnecting an inlet and an outlet of the first humidifier 38 via a third pump 771 and the third heat exchanger HEX03, and a tenth pipeline 78 interconnecting an inlet and an outlet of the second humidifier 48 via a fourth pump 781 and the second and third heat exchangers HEX02, HEX03. The inlet of the first humidifier 38 is connected to a water sprayer (not labeled) thereof for humidifying the hydrogen flowing through the first humidifier 38. The outlet of the first humidifier is connected to a water collector (not labeled) thereof for collecting condensed water in the first humidifier 38. The water sprayer and collector of the first humidifier 38 are located at top and bottom thereof, respectively. The inlet of the second humidifier 48 is connected to a water sprayer (not labeled) thereof for humidifying the air flowing through the second humidifier 48. The outlet of the second humidifier is connected to a water collector (not labeled) thereof for collecting condensed water in the second humidifier 48. The water sprayer and collector of the second humidifier 48 are located at top and bottom thereof, respectively.

The first to third heat exchangers HEX01-HEX03 each are a liquid-to-liquid heat exchanger, for transferring thermal energy between two flow channels; thus, the fluids at the hot end and the cold end do not meet with each other thereby to ensure that the purity of the coolant flow is maintained. The fourth heat exchanger HEX04 is a gas-to-gas plate heat exchanger, for transferring thermal energy from the cathode exhaust stream to the ambient air inlet gas stream. The fifth heat exchanger HEX05 is a gas-to-liquid condenser, for condensing the water vapor in the cathode exhaust stream from the outlet of the cathode 24. The cathode exhaust stream first flows through the fourth heat exchanger HEX04 and then the fifth heat exchanger HEX05, whereby the water vapor in the exhaust stream which has an elevated temperature is sufficiently cooled to become water droplets. The cooled water droplets are collected at the product water tank 62.

In operation of the fuel cell power generating system 10, air with an elevated temperature and humidity is fed into the cathode 24 and hydrogen with an elevated temperature and humidity is fed into the anode 22 of the fuel cell module 20, whereby electrical current is produced by a reaction between the oxygen in the air and the hydrogen. Hot water in the cooling plate 52 which is heated by the reaction of the hydrogen and oxygen in the fuel cell module 20 passes through the second and first heat exchangers HEX02, HEX01 via a drive of the first pump 54 to circulate through the fourth pipeline 58. The temperature of the hot water is lowered after it flows through the second and first heat exchangers HEX02, HEX01 and before it enters the fuel cell module 20. The cold end of the first heat exchanger HEX01 is connected to the cooling tower 72 via the seventh pipeline 75, wherein the cooling tower 72 dissipates the heat by spraying the hot fluid within an enclosure of the cooling tower 72. The cooled fluid spray is then collected at the bottom of the cooling tower 72 and recycled back to first heat exchanger HEX01 via a drive of the second pump 74 which is disposed along the seventh pipeline 75. The coolant tank 56 is disposed along the fourth pipeline 58 to supply the water to the fourth pipeline 58 when needed.

The second heat exchanger HEX02 is disposed between the outlet of the fuel cell module 20 and the inlet of the first heat exchanger HEX01 along the fourth pipeline 58. The second heat exchanger HEX02 receives thermal energy from the fluid in the fourth pipeline 58 prior to the first heat exchanger HEX01 and transfers the heat to the fluid in the tenth pipeline 78, wherein the hot fluid in the tenth pipeline 78 is sprayed onto the packed-beds of the second humidifier 48 for heating and humidifying the inlet air stream. The excess cooled fluid in the second humidifier 48 is then collected at the bottom of the second humidifier 48 and then recycled back to the second heat exchanger HEX02 via a drive of the fourth pump 781 along the tenth pipeline 78.

The third heat exchanger HEX03 is disposed between the outlet of the second heat exchanger HEX02 and the inlet of the second humidifier 48 along the tenth pipeline 78. The third heat exchanger HEX03 receives thermal energy from the fluid in the tenth pipeline 78 and transfers the heat to the fluid in the ninth pipeline 77, where the hot fluid in the ninth pipeline 77 is sprayed onto the packed-beds of the first humidifier 38 for heating and humidifying the inlet hydrogen gas stream. The excess cooled fluid in the first humidifier 38 is then collected at the bottom of the first humidifier 38 and recycled back to the third heat exchanger HEX03 via a drive of the third pump 771 along the ninth pipeline 77.

The fourth heat exchanger HEX04 is disposed along the downstream of the exhaust of the cathode 24 which has an eleventh pipeline 241 connecting the exhaust of the cathode 24 and an air inlet of the fifth heat exchanger HEX05 via the fourth heat exchanger HEX04. The fourth heat exchanger HEX04 is also connected to the ambient air inlet stream between the air filter 44 and the air blower 46. The fourth heat exchanger HEX04 receives thermal energy from the cathode exhaust stream which is humid air in the eleventh pipeline 241, and transfer the heat to the inlet air flow to heat up the ambient air stream in the third pipeline 49 before the ambient air stream enters the second humidifier 48.

The fifth heat exchanger HEX05 acts as a condenser and replaces the conventional drain trap (which has poorer water condensation efficiency). The fifth heat exchanger HEX05 is disposed along the downstream of the cathode exhaust subsequent to the fourth heat exchanger HEX04. The fifth heat exchanger HEX05 receives the cathode exhaust stream subsequent to the fourth exchanger HEX04, where the fifth heat exchanger HEX05 transfers the heat from the cathode exhaust stream to the fluid in the eighth pipeline 76. The eighth pipeline 76 is connected to the seventh pipeline 75, and the thermal enemy is dissipated from the eighth pipeline 76 through the seventh pipeline 75 to the cooling tower 72. The cooling of the cathode exhaust stream by the fifth heat exchanger HEX05 produces water condensation. The dehumidified cathode exhaust stream together with the condensed water flows to the product water tank 62, where the condensed water can be collected to supplement to the product water 61. The dehumidified cathode exhaust stream is then exhausted to the atmosphere from the product water tank 62. The recycled product water 61 in the product water tank 62 is then supplied via a drive of a pump (not shown) to refill the first humidifier 38, the second humidifier 48 and the coolant tank 56.

According to the present disclosure, the first to fifth heat exchangers HEX01-HEX05 are arranged in a way such that a substantial thermal energy produced by the chemical reaction in the fuel cell module 20 is firstly recovered and utilized in the heat exchangers HEX01-HEX05 before the heat is transferred to the cooling tower 72. Accordingly, the heat generated by the fuel cell module 20 can be effectively reused. In addition, the heat exchangers HEX01-HEX05 are configured in parallel to maintain a low flow resistance of the fluid flow channels coupled to the fuel cell module 20, thereby to reduce the power consumption of the pumps coupled to the fluid flow channels.

Particularly, in the present disclosure, the hot water from the fuel cell module 20 is firstly guided to the second heat exchanger HEX02, as it requires greater amount of the thermal energy to heat up and humidify large amount of air stream. Only the remaining thermal energy of the hot water is then transferred to the first heat exchanger HEX01 and dissipated by the cooling tower 72, whereby more thermal energy is recycled to be utilized in the system 10. The third heat exchanger HEX03 requires smaller amount of thermal energy for heating up and humidifying the relative smaller amount of hydrogen gas; therefore, the third heat exchanger HEX03 receives thermal energy from the second heat exchanger HEX02. Such arrangement reduces the power consumption of the first pump 54 coupled to the fourth pipeline 58, since the flow resistance is low. In addition, such arrangement reduces the needs of constant monitoring and adjusting the overall system thermal fluctuations and hence achieves a more stable system. Moreover, such arrangement eliminates the risk of creating volatile gas from mixing between the hydrogen gas and the air.

The fourth heat exchanger HEX04 receives the hot cathode exhaust stream directly from the fuel cell module 20 so a large portion of the thermal energy in the hot cathode exhaust stream is transferred to heat up the ambient air inlet stream. Only the remaining thermal energy of the cathode exhaust stream is subsequently transported to the fifth heat exchanger HEX05, where the water vapor in the cathode exhaust stream is condensed ad collected at the product water tank 62 by dissipating the heat from the cathode exhaust stream to the cooling tower 72. This arrangement ensures a larger portion of the heat generated by the reaction of the oxygen and hydrogen in the fuel cell module 20 is utilized in the system 10 and only a small amount of thermal energy is dissipated through the cooling tower 72.

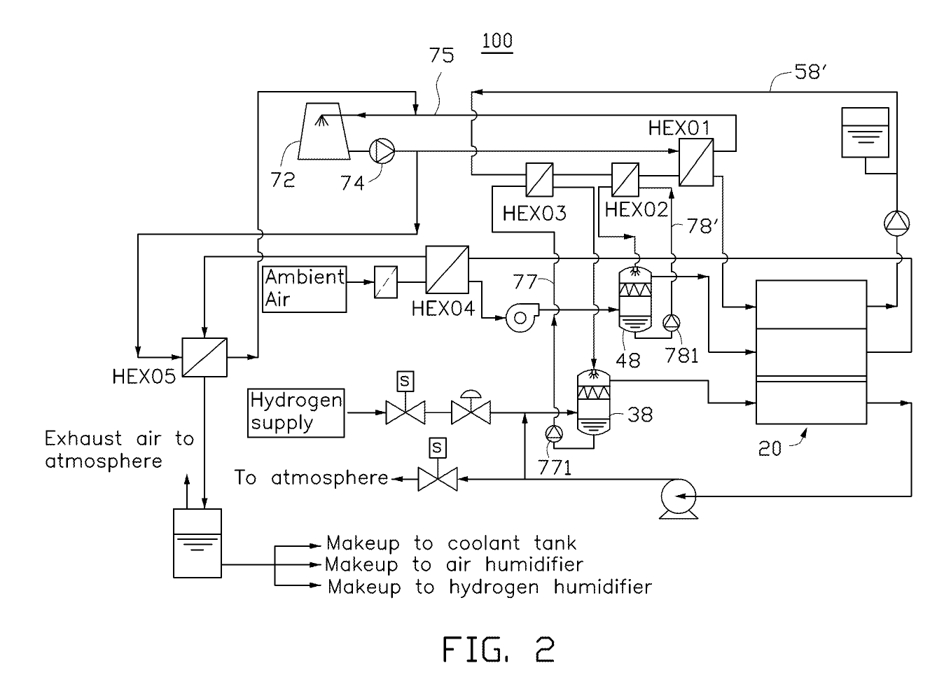

A fuel cell power generating system 100 in accordance with a second embodiment of the present disclosure is shown in FIG. 2, which is substantially similar to the first embodiment, except the different arrangements of the fourth pipeline 58′, the tenth pipeline 78′ and the first to third heat exchangers HEX01-HEX03.

According to the second embodiment, the third heat exchanger HEX03 is arranged in a way such that it receives the initial thermal energy from the fuel cell module 20 through the fourth pipeline 58′ and transfers the heat to the fluid in the ninth pipeline 77, wherein the hot fluid in the ninth pipeline 77 is sprayed onto the packed-beds of the first humidifier 38 for heating and humidifying the inlet hydrogen gas stream. The excess cooled fluid in the first humidifier 38 is then collected at the bottom of the first humidifier 38 and recycled back to the third heat exchanger HEX03 via a drive of the third pump 771 along the ninth pipeline 77.

The hot water in the fourth pipeline 58′ subsequent to the third heat exchanger HEX03 flows to the second heat exchanger HEX02 and transfers the remaining heat to the fluid in the tenth pipeline 78′, where the hot fluid in the tenth pipeline 78′ is sprayed onto the packed-beds of the second humidifier 48 for heating and humidifying the ambient air inlet stream. The excess cooled fluid in the second humidifier 48 is then collected at the bottom of the second humidifier 48 and recycled back to the second heat exchanger HEX02 via a drive of the fourth pump 781 along the tenth pipeline 78′.

The hot water in the fourth pipeline 58′ subsequent to the second heat exchanger HEX02 flows to the first heat exchanger HEX01 and transfers the remaining heat to the fluid in the seventh pipeline 75, where the hot fluid in the seventh pipeline 75 is cooled by spraying within the enclosure of the cooling tower 72. The excess cooled fluid in the cooling tower 72 is then collected at the bottom of the cooling tower 72 and recycled back to the first heat exchanger HEX01 via a drive of the second pump 74 along the seventh pipeline 75.

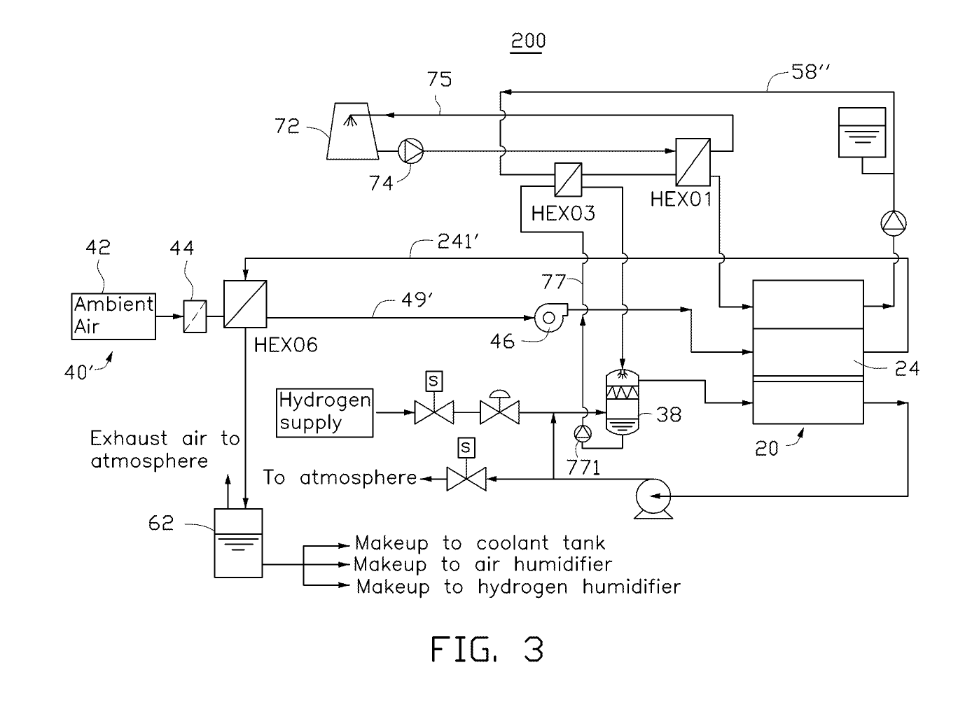

A fuel cell power generating system 200 in accordance with a third embodiment of the present disclosure is shown in FIG. 3, which is substantially similar to the first embodiment, except the different arrangements of the air supply subassembly and the heat exchangers.

In the third embodiment, the third heat exchanger HEX03 is arranged in a way such that it receives the initial thermal energy from the fuel cell module 20 through the fourth pipeline 58″ and transfers the heat to the fluid in the ninth pipeline 77, wherein the hot fluid in the ninth pipeline 77 is sprayed onto the packed-beds of the first humidifier 38 for heating and humidifying the inlet hydrogen gas stream. The excess cooled fluid in the first humidifier 38 is then collected at the bottom of the first humidifier 38 and recycled back to the third heat exchanger HEX03 via a drive of the third pump 771 along the ninth pipeline 77.

The hot water in the fourth pipeline 58″ subsequent to the third heat exchanger HEX03 flows to the first heat exchanger HEX01 and transfers the remaining heat to the fluid in the seventh pipeline 75, where the hot fluid in the seventh pipeline 75 is cooled by spraying within the enclosure of the cooling tower 72. The excess cooled fluid in the cooling tower 72 is then collected at the bottom of the cooling tower 72 and recycled back to the first heat exchanger HEX01 via a drive of the second pump 74 along the seventh pipeline 75. In this embodiment, the second, fourth and fifth heat exchangers HEX02, HEX04, HEX05 of the first embodiment are omitted, wherein the fourth and fifth heat exchangers HEX04, HEX05 are replaced by a sixth heat exchanger HEX06 in the third embodiment, which combines the functions of a condenser, a pre-heater and a humidifier in a single unit. Furthermore, the air (oxidant) supply subsystem 40′ of the fuel cell power generating system 200 includes an ambient air supply 42, a filter 44, a blower 46 and a third pipeline 49′ which interconnects the ambient air supply 42, the filter 44 and the blower 46 together and connects the blower 46 of the air (oxidant) supply subsystem 40′ with an inlet of the cathode 24 of the fuel cell module 20.

The sixth heat exchanger HEX06 is disposed along the downstream of the cathode exhaust of the fuel cell module 20 and is connected to the ambient inlet stream, between the air filter 44 and the air blower 46. The sixth heat exchanger HEX06 transfers the heat from the cathode exhaust stream through the eleventh pipeline 241′ to the ambient air inlet stream. As the heat is removed from the cathode exhaust stream, water condensation is produced and collected in the product water tank 62 disposed along the downstream of the cathode exhaust, subsequent to the sixth heat exchanger HEX06. This arrangement can result in a lower water condensation. Both the heat and mass are transferred via the sixth heat exchanger HEX06, which can be for example, a desiccant/heat recovery rotor.

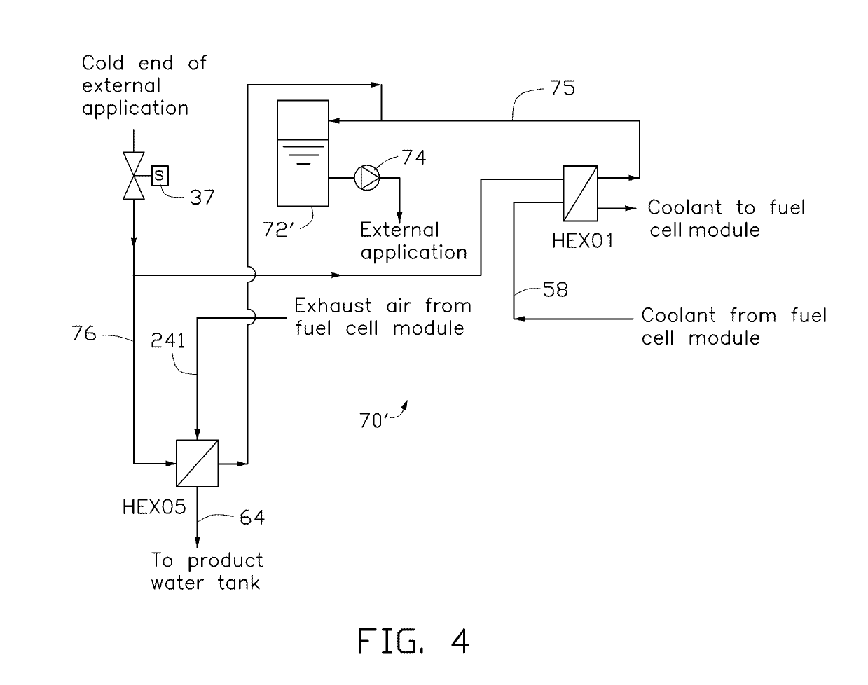

FIG. 4 shows a partial configuration of a fuel cell power generating system according to a fourth embodiment, which is substantially similar to the first and second embodiments, except the arrangement of the thermal management subsystem 70′. In the thermal management subsystem 70′ according to this embodiment, a hot water tank 72′ is used to replace the cooling tower 72 of the first and second embodiments. The hot water tank 72′ can be connected to external applications such as household hot water for bathing or warm water for room heating and supply the stored hot water when needed. The hot water is supplied to the external applications by a drive of the second pump 74. A cold water supply valve 37 is connected to the cold end of the external application and the cold water supply valve 37 is disposed along the eighth pipeline 76 prior to the fifth heat exchanger HEX05, where cold water from the external application is heated up by flowing through the fifth heat exchanger HEX05 to receive the heat from the cathode exhaust stream and in the same time through the seventh pipeline 75 to receive the thermal energy from the first heat exchanger HEX01, and eventually flows to and is stored in the hot water tank 72′. It can be understood that if the thermal management subsystem 70′ is used in the first embodiment, the fourth pipeline 58 can connect with the second heat exchanger HEX02 before it connects with the first heat exchanger HEX01. Furthermore, it can also be understood that if the thermal management subsystem 70′ is used in the second embodiment, the fourth pipeline 58 can connect with the third and then the second heat exchangers HEX03, HEX02 before it connects with the first heat exchanger HEX01.

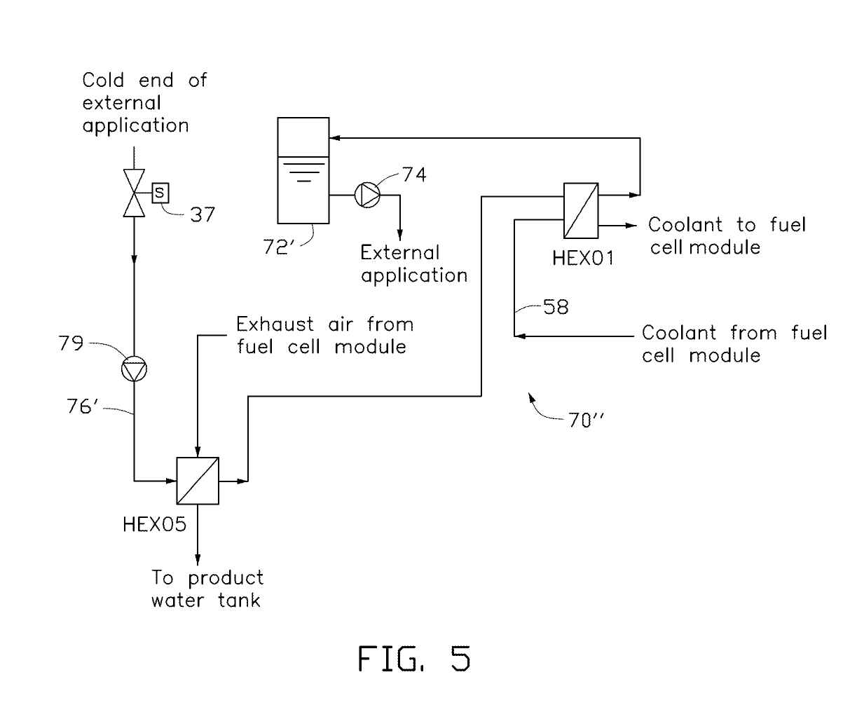

FIG. 5 shows a partial configuration of a fuel cell power generating system according to a fifth embodiment, which is substantially similar to the first and second embodiments, except the arrangement of the thermal management subsystem 70″. The thermal management subsystem 70″ is substantially the same as the thermal management subsystem 70′ except that a twelfth pipeline 76′ is used to replace the eighth pipeline 76 and the seventh pipeline 75. The twelfth pipeline 76′ connects the cold water supply valve 37 which is connected to the cold end of the external application, a fifth pump 79, the fifth heat exchanger HEX05, the first heat exchanger HEX01 and the hot water tank 72′ in series. Accordingly, the cold water from the cold end of the external application is heated up by flowing through the fifth heat exchanger HEX05 to receive the thermal energy from the cathode exhaust stream and then through the first heat exchanger HEX01 to receive the thermal energy transferred from the hot water in the fourth pipeline 58, and eventually flows to and is stored in the hot water tank 72′. When in demand of hot water supply, the stored hot water in the hot water tank 72′ is transferred to the external application through a drive of the second pump 74 disposed near an outlet of the hot water tank 72′.

It is to be understood that the above-described embodiments are intended to illustrate rather than limit the disclosure. Variations can be made to the embodiments without departing from the spirit of the disclosure as claimed. The above-described embodiments illustrate the scope of the disclosure but do not restrict the scope of the disclosure.

What is claimed is:

1. A fuel cell power generating system comprising:
a fuel cell module having a cathode and an anode;
a hydrogen supply in fluid communication with the anode via a first channel for supplying hydrogen to the anode;
an air supply in fluid communication with the cathode via a second channel for supplying air to the cathode, wherein when the hydrogen has a reaction with oxygen of the air in the fuel cell module, electrical current is generated across the anode and the cathode; and
a cooling subsystem in thermal connection with the fuel cell module for taking heat generated by the reaction away from the fuel cell module via a third channel, the cooling subsystem having coolant circulating in the third channel;
wherein the cooling subsystem is also in thermal connection with at least one of the hydrogen supply and the air supply for heating at least one of the hydrogen and the air before the at least one of the hydrogen and the air enters the fuel cell module.

2. The fuel cell power generating system of claim 1, wherein the cooling subsystem comprises a first heat exchanger and a cooling tower, heat in the coolant being transferred to the cooling tower through the first heat exchanger, and wherein the air supply has an air humidifier for heating and humidifying the air before the air enters the cathode of the fuel cell module, a first circulation pipeline circulating first fluid to flow repeatedly through the air humidifier and a second heat exchanger, the heat in the coolant being transferred to the first fluid via the second heat exchanger.

3. The fuel cell power generating system of claim 2, wherein the coolant flows first through the second heat exchanger and then the first heat exchanger after the coolant absorbs the heat from the fuel cell module.

4. The fuel cell power generating system of claim 3, wherein the hydrogen supply comprises a hydrogen humidifier for heating and humidifying the hydrogen before the hydrogen enters the anode of the fuel cell module, a second circulation pipeline circulating second fluid to flow repeatedly through the hydrogen humidifier and a third heat exchanger, heat in the first fluid being transferred to the second fluid via the third heat exchanger.

5. The fuel cell power generating system of claim 4, wherein the first fluid flows first through the second heat exchanger and then the third heat exchanger after the first fluid leaves the air humidifier.

6. The fuel cell power generating system of claim 2, wherein the hydrogen supply comprises a hydrogen humidifier for heating and humidifying the hydrogen before the hydrogen enters the anode of the fuel cell module, a second circulation pipeline circulating second fluid to flow repeatedly through the hydrogen humidifier and a third heat exchanger, and wherein the heat in the coolant is first transferred to the second fluid via the third heat exchanger, then to the first fluid via the second exchanger and finally to the cooling tower through the first heat exchanger after the coolant receives the heat from the fuel cell module.

7. The fuel cell power generating system of claim 1, wherein the hydrogen supply comprises a hydrogen humidifier for heating and humidifying the hydrogen before the hydrogen enters the anode of the fuel cell module, a second circulation pipeline circulating second fluid to flow repeatedly through the hydrogen humidifier and a third heat exchanger, the heat in the coolant being transferred to the second fluid via the third heat exchanger and then to the cooling tower via the first heat exchanger after the coolant receives heat from the fuel cell module, and wherein the air supply has a fourth heat exchanger, which combines the functions of a condenser, a pre-heater and a humidifier in a single unit, the fourth heat exchanger receiving a cathode exhaust stream from the cathode to heat and humidify the air before the air enters the cathode of the fuel cell module.

8. The fuel cell power generating system of claim 1, wherein the cooling subsystem comprises a first heat exchanger and a hot water tank, heat in the coolant being transferred to water through the first heat exchanger to heat the water, the heated water being stored in the hot water tank and configured for external application.

9. The fuel cell power generating system of claim 8 further comprising a fifth heat exchanger receiving a cathode exhaust stream from the cathode of the fuel cell module, heat in the cathode exhaust stream being transferred to the water through the fifth heat exchanger while the heat in the coolant is transferred to the water through the first heat exchanger.

10. The fuel cell power generating system of claim 8 further comprising a fifth heat exchanger receiving a cathode exhaust stream from the cathode of the fuel cell module, heat in the cathode exhaust stream being transferred to the water through the fifth heat exchanger before the heat in the coolant is transferred to the water through the first heat exchanger.

11. The fuel cell power generating system of claim 4 further comprising a fifth heat exchanger receiving a cathode exhaust stream from the cathode of the fuel cell module and water from the cooling tower, heat in the cathode exhaust stream being transferred to the water through the fifth exchanger to thereby condense moisture in the cathode exhaust stream into water.

12. The fuel cell power generating system of claim 11 further comprising a sixth heat exchanger receiving the cathode exhaust stream from the cathode of the fuel cell module before the fifth heat exchanger receives the cathode exhaust stream, and wherein heat in the cathode exhaust stream is transferred to the air through the sixth heat exchanger before the air enters the fuel cell module.

13. The fuel cell power generating system of claim 11, wherein the water obtained by condensing the moisture in the cathode exhaust stream is used for providing makeup to at least one of the coolant in the cooling subsystem, the first fluid for the air humidifier and the second fluid for the hydrogen humidifier.

14. The fuel cell power generating system of claim 13 further comprising a recirculation pump in fluid communication with an exhaust of the anode and an inlet of the hydrogen humidifier.

15. A fuel cell power generating system comprising:
a fuel cell module having an anode and a cathode;
a cooling subsystem circulating coolant through the fuel cell module to take away heat generated thereby when the fuel cell module is operated to generate electricity;
a hydrogen supply for supplying hydrogen to the anode of the fuel cell module through a hydrogen humidifier;
an oxygen supply for supplying oxygen to the cathode of the fuel cell module through an oxygen humidifier;
a first heat exchanger for transferring heat in the coolant which is obtained by absorbing the heat generated by the fuel cell module to a first fluid;
a second heat exchanger for transferring the heat in the coolant to a second fluid;
a third heat exchanger for transferring heat in the second fluid which is obtained by absorbing the heat in the coolant to a third fluid;
wherein the first fluid flows to one of a cooling tower and a tank after receiving the heat in the coolant, the cooling tower being for dissipating heat in the first fluid and the tank being for accumulating the first fluid therein which is configured for an external application;
wherein the second fluid is circulated through the oxygen humidifier for heating and humidifying the oxygen before it enters the cathode; and
wherein the third fluid is circulated through the hydrogen humidifier for heating and humidifying the hydrogen before it enters the anode.

16. The fuel cell power generating system of claim 15, further comprising a fourth heat exchanger for transferring heat in a cathode exhaust stream from the cathode of the fuel cell module to the oxygen before the oxygen enters the oxygen humidifier.

17. The fuel cell power generating system of claim 16, further comprising a fifth heat exchanger for transferring the heat in the cathode exhaust stream from the cathode of the fuel cell module to a fifth fluid to thereby condense moisture in the cathode exhaust stream into liquid, the fifth heat exchanger transfers the heat in the cathode exhaust stream to the fifth fluid after the fourth heat exchanger transfers the heat in the cathode exhaust stream to the oxygen.

18. The fuel cell power generating system of claim 17, wherein the liquid is used for providing a makeup to at least one of the coolant, the second fluid and the third fluid.

19. The fuel cell power generating system of claim 17, wherein when the first fluid flows to the tank for external application, a cold end of the external application is connected with the first heat exchanger and the fifth heat exchanger in parallel.

20. The fuel cell power generating system of claim 17, wherein when the first fluid flows to the tank for external application, a cold end of the external application is connected with the fifth heat exchanger and then the first heat exchanger in series.

21. A fuel cell power generating system comprising:
a fuel cell module having an anode and a cathode;
a cooling subsystem circulating coolant through the fuel cell module to take away heat generated thereby when the fuel cell module is operated to generate electricity;
a hydrogen supply for supplying hydrogen to the anode of the fuel cell module through a hydrogen humidifier;
an air supply for supplying oxygen to the cathode of the fuel cell module through a first heat exchanger which combines functions of a condenser, a pre-heater and a humidifier into a single unit;
a second heat exchanger for transferring heat in the coolant which is obtained by absorbing the heat generated by the fuel cell module to a first fluid;
a third heat exchanger for transferring the heat in the coolant to a second fluid;
wherein a cathode exhaust stream flows to the first heat exchanger to heat and humidify the air before the air enters the cathode of the fuel cell module, moisture in the cathode exhaust stream being condensed into liquid after heat in the cathode exhaust stream is transferred to the air by the first heat exchanger; and
wherein the second fluid is circulated through the hydrogen humidifier for heating and humidifying the hydrogen before it enters the anode.
